(19) United States
(12) Patent Application Publication
(10) Pub. No.: US 2010/0167665 A1
(43) Pub. Date: Jul. 1, 2010

(54) Enhanced error correction performance

(75) Inventor: Tommi J. Zetterman, Espoo (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/319,125

(22) Filed: Dec. 30, 2008

(51) Int. Cl. H04B 1/44

(52) U.S. Cl. 455/78

(57) ABSTRACT

The exemplary embodiments of this invention relate in part to an apparatus that includes an error correction function and a controller configured to receive radio access scheduling information in response to a scheduling request sent to a multiradio controller. The controller is responsive to the radio access scheduling information containing an indication of a time when during a scheduling interval reception is blocked for a receiver of the apparatus, due at least in part to simultaneously scheduled operation of a transmitter, to send information to the error correction function for marking as erased any symbols received during a time that the reception is indicated to be blocked. The exemplary embodiments of this invention may be realized at least in part in a software defined radio platform that includes the multiradio controller and a plurality of radio access units.

### TECHNICAL FIELD

The exemplary and non-limiting embodiments of this invention relate generally to wireless communication systems, methods, devices and computer programs and, more specifically, relate to software defined radio, as well as multi-radio interoperability control and error correction algorithms.

### BACKGROUND

Various abbreviations that appear in the specification and/or in the drawing figures are defined as follows:

FEC forward error correction

MPE multiprotocol encapsulation

MRC multiradio controller

SDR software defined radio

A software defined radio (SDR) describes a concept where many radio functions that were typically implemented in hardware may be implemented in software.

FEC is a system of error control for data transmission where the sender adds redundant data to messages, also known as an error correction code. This allows the receiver to detect and correct errors (within limits) without the need to request additional data from the sender. Advantages of FEC include removing a need for a back channel between the sender and the receiver, and the avoidance of retransmissions (at the cost of higher bandwidth requirements on average). The maximum fraction of errors that can be corrected is determined in advance by the design of the code, so different forward error correcting codes are suitable for use under different conditions.

FEC is accomplished by adding redundancy to the transmitted information using a predetermined algorithm. Each redundant bit is invariably a complex function of many original information bits. The original information may or may not appear in the encoded output; codes that include the unmodified input in the output are systematic, while those that do not are non-systematic.

The two main types of FEC involve block coding and convolutional coding. Block codes operate with fixed-size blocks (e.g., packets) of bits or symbols of predetermined size, while convolutional codes operate on bit or symbol streams of arbitrary length.

There are a number of types of block codes. One of the most commonly used is Reed-Solomon coding, although Golay, BCH and Hamming codes are other examples of block codes. Most if not all block codes apply the algebraic properties of finite fields.

Many FEC algorithms (e.g., Reed-Solomon) can correct more errors per block if the exact positions of erroneous symbols are known in advance.

Commonly owned US Patent Application Publication US2007/0064835, “Interoperability improvement in terminals having a transmitter interfering with a receiver” describes an apparatus where the transmitter informs the receiver of transmit bursts, which can then perform various countermeasures to reduce the effect of interference.

A problem can arise in multiradio types of platforms, such as software defined radio platforms having a multiradio controller and a plurality of radios. The problem relates at least in part to the overall scheduling of the radios and the possibility of blocking a scheduled reception by one radio due to a scheduled transmission by another radio.

### SUMMARY

The foregoing and other problems are overcome, and other advantages are realized, by the use of the exemplary embodiments of this invention.

In a first aspect thereof the exemplary embodiments of this invention provide an apparatus that comprises a controller configured to provide radio access scheduling services for a plurality of radio access units in response to scheduling requests received from the plurality of radio access units. The controller is configurable with a scheduler that is configured to schedule radio access in response to received scheduling requests and to send radio access scheduling information to the plurality of radio access units. The scheduling information comprises an indication of when during a scheduling interval reception is blocked for a receiver of a particular one or ones of the radio access units due at least in part to simultaneously scheduled operation of a transmitter.

In another aspect thereof the exemplary embodiments of this invention provide a method that comprises receiving scheduling requests from a plurality of radio access units and, in response to received scheduling requests, scheduling the radio access units for performing radio access and sending radio access scheduling information to the plurality of radio access units. The scheduling information comprises an indication of when during a scheduling interval reception is blocked for a receiver of a particular one or ones of the radio access units due at least in part to simultaneously scheduled operation of a transmitter.

In another aspect thereof the exemplary embodiments of this invention provide a method that comprises receiving radio access scheduling information from a multiradio controller, the scheduling information comprising an indication of a time when during a scheduling interval reception is blocked for a receiver due at least in part to simultaneously scheduled operation of a transmitter, and sending information to an error correction function for marking as erased any symbols received during a time that the reception is indicated to be blocked.

In yet another aspect thereof the exemplary embodiments of this invention provide an apparatus that comprises an error correction function and a controller configured to receive radio access scheduling information in response to a scheduling request sent to a multiradio controller. The controller is responsive to the radio access scheduling information comprising an indication of a time when during a scheduling interval reception is blocked for a receiver of the apparatus, due at least in part to simultaneously scheduled operation of a transmitter, to send information to the error correction function for marking as erased any symbols received during a time that the reception is indicated to be blocked.

### BRIEF DESCRIPTION OF THE DRAWINGS

In the attached Drawing Figures:

FIG. 1 depicts a SDR platform having a MRC and a plurality of controlled radios, and also shows a series of steps illustrating how the MRC collects information needed to inform a radio FEC decoder of erasures during a multiradio scheduling process.

FIG. 2 shows an additional embodiment, where the MRC is also made aware of a non-radio interference phenomenon.

FIGS. 3-9 are useful in describing exemplary MRC scheduling operations, where FIG. 3 illustrates a simplified block diagram of an apparatus that comprises first and second radio access units and a MRC for controlling co-existence between the radio access units; FIG. 4a shows an embodiment of the multiradio controller that includes a scheduling service controller (scheduler), a request receiver and a response sender; FIG. 4b shows an embodiment of a radio access unit that includes a controller, a request sender and a response receiver; FIG. 5 is a logic flow diagram that depicts the operations of a radio access unit in generating a request and receiving a response from the multiradio controller; FIG. 6 is a logic flow diagram that depicts the operations of the multiradio controller and scheduler thereof in receiving requests and responding to the requests with a generated radio access schedule; FIG. 7 illustrates an example of how time windows may be allocated to different types of scheduling requests; FIG. 8 is a logic flow diagram that depicts the operation of the scheduler of the multiradio controller; and FIG. 9 presents a table of exemplary parameters for various scheduling request categories, including periodic type of radio access, continuous type of radio access and single type of radio access.

FIG. 10 is a more detailed block diagram of the SDR platform of FIG. 1.

FIG. 11 is a logic flow diagram that illustrates the operation of a method, and a result of execution of computer program instructions, for the MRC controller of FIGS. 1 and 10 in accordance with the exemplary embodiments of this invention.

FIG. 12 is a logic flow diagram that illustrates the operation of a method, and a result of execution of computer program instructions, for one of the radio access units of FIGS. 1 and 10 in accordance with the exemplary embodiments of this invention.

### DETAILED DESCRIPTION

A MRC may be considered herein in a non-limiting case to be a SDR platform component capable of determining interoperability problems between different concurrently running radios, and resolving such problems by denying or restricting one or more radios from performing its activity when it disturbs another radio or radios. This type of operation may be referred to as multiradio scheduling. One non-limiting example of how multiradio scheduling can be accomplished is presented in FI 20085480, “Co-existence between radio access units”, described in further detail below.

The exemplary embodiments of this invention improve the error correction capability of an error correction function, such as one embodied as a FEC algorithm of a radio receiver of a radio unit in a SDR platform, without a need for an individual radio application to know of the existence of other, possibly interfering radios. The exemplary embodiments of this invention provide an ability for a SDR platform to determine and resolve interoperability problems between different radios. The exemplary embodiments of this invention provide the SDR platform with a functionality to obtain information about detected time slots when the reception of one or more of the radios is blocked because of interference from another radio or from some other source, and to forward the information to one or more receivers. The receivers may then use this information to improve error correction performance, such as FEC performance, by marking known error positions as erasures. In that this information is created and provided by the SDR platform, there is no need for an individual radio to know the identities of which other radios are concurrently executing.

The exemplary embodiments of this invention further provide for the addition of new radios to be run at the SDR platform, where both new and previously instantiated radios can utilize multiradio scheduling information to improve error correction performance.

The use of these exemplary embodiments enables at least the following application cases and scenarios to exist:

a new radio receiver may be added later, and may utilize information concerning time period reception that is corrupted because of a simultaneously active transmitter, even when the existing transmitter does not have knowledge of the new receiver; and

a new radio transmitter may be added later, and previously existing receivers may utilize information concerning time periods when their reception is corrupted because of the simultaneously active new transmitter, even when the existing receivers do not have knowledge of the new transmitter.

The exemplary embodiments of this invention utilize multiradio scheduling information, which may be available as a SDR platform service, to inform radio(s) of those time periods where reception is corrupted or degraded due to a simultaneously active transmitter.

The exemplary embodiments of this invention thus provide an improved multiradio SDR (one capable of running multiple simultaneous radios).

A number of advantages can be realized by the use of the multiradio SDR. For example, blocking information can be made exact both in a time sense (as the MRC has exact information as to when radio reception is disturbed) and in an accuracy sense (false alarms are avoided). Further by example, the SDR platform assumes responsibility for gathering and transferring needed information. This allows the addition of new radio(s) to the multiradio SDR, and supports erasure marking without a need for peer-to-peer knowledge and information transfer between all or some of the radios. A still further exemplary advantage is that phenomenon other than antenna-to-antenna interference can be used to mark erroneous symbols as erasures, assuming that the MRC has the pertinent knowledge.

Describing now the exemplary embodiments of this invention in further detail, the SDR platform, which is capable of executing multiple radios simultaneously, has a control entity that may be referred to for convenience as the multiradio controller (MRC). The MRC dynamically detects interoperability problems between radios, and solves these problems by blocking or adjusting the behavior of one or more of the conflicting radios. The exemplary embodiments of this invention provide in one aspect thereof a method to increase the performance of an error correction algorithm, such as a FEC algorithm, in the SDR platform by collecting information during a multiradio scheduling process. This information may include information descriptive of time periods when radio reception is corrupted. This information is transferred to “victim” receivers of the SDR, which can utilize the information to mark received symbols associated with blocked time periods as known errors (also referred to as “erasures”).

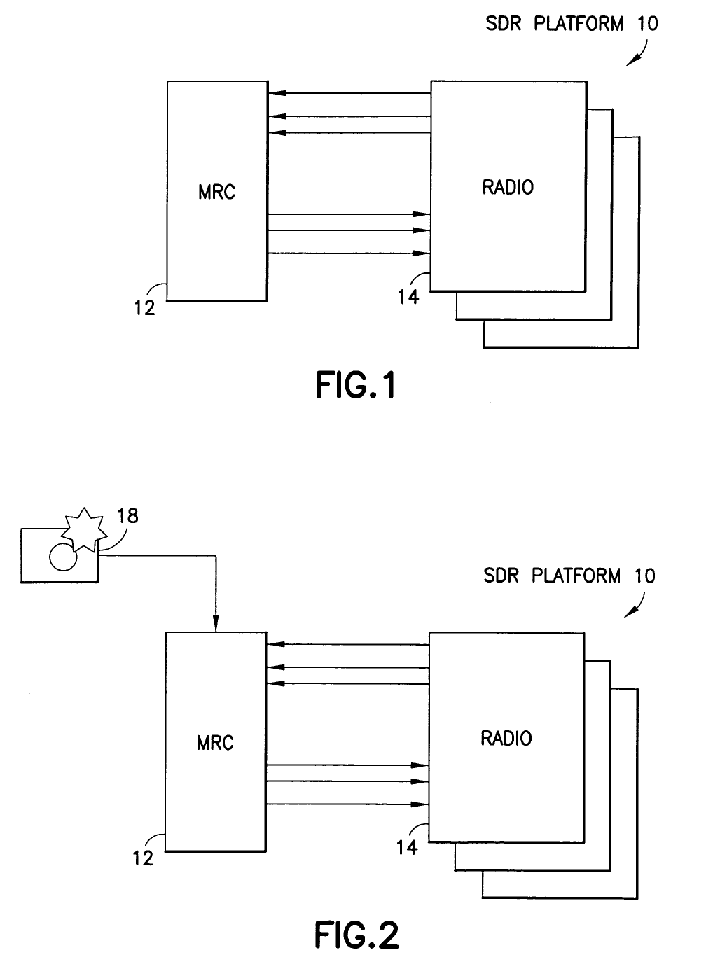

Referring to FIG. 1, a SDR platform 10 contains a multiradio controller (MRC) 12 that is responsible of dynamically detecting conflicts when two or more radios (which may also be referred to as radio access units or RAUs) 14 interfere with each other, and responds by either by blocking one or more of the radios 14 or, if allowed, by adjusting parameters (e.g., transmit power, transmit time). One exemplary and non-limiting MRC scheduling concept is described in the above mentioned FI 20085480, “Co-existence between radio access units”.

Before describing the exemplary embodiments of this invention in further detail, the particular multiradio scheduling approach described in FI 20085480 will be briefly described with reference to FIGS. 3, 4, 5, 6, 7, 8 and 9. It should be realized that this particular multiradio scheduling approach is but one example of a number of different multiradio scheduling approaches that may be used, and is not to be construed in a limiting sense with respect to the implementation and operation of the exemplary embodiments of this invention.

FIG. 3 illustrates a simplified block diagram of an apparatus 100 that comprises a first radio access unit (RAU) 120, a second radio access unit 140, and a multiradio controller (MRC) 160 for controlling co-existence between the RAUs 120, 140. A given one of the RAUs 120, 140, which may also be referred to as a radio access system, communicator or a communications unit, may be a transmitter, a receiver, or a transceiver. The RAUs 120, 140 are communicatively connectable to a single antenna 20 or to multiple antennas. The RAUs 120, 140 may be located in separate or separable devices.

The apparatus 100 may be considered to be or represent a SDR platform.

The MRC 160 is arranged to control coexistence between the RAUs 120 and 140 by providing a radio access scheduling service for the radio access units 120,140. The MRC 160 may function as a scheduling service controller for providing radio access scheduling services for a plurality of radio access units 120, 140 over a predefined control interface 180 with a set of radio independent scheduling parameters for the radio access units 120, 140. When a RAU 120, 140 has a need to receive or transmit, it requests air access time by sending a scheduling request to the MRC 160. The MRC 160 collects scheduling requests from different RAUs, resolves possible interoperability problems and sends decisions back to the RAUs 120, 140. These decisions may be in the form of a schedule, as described below.

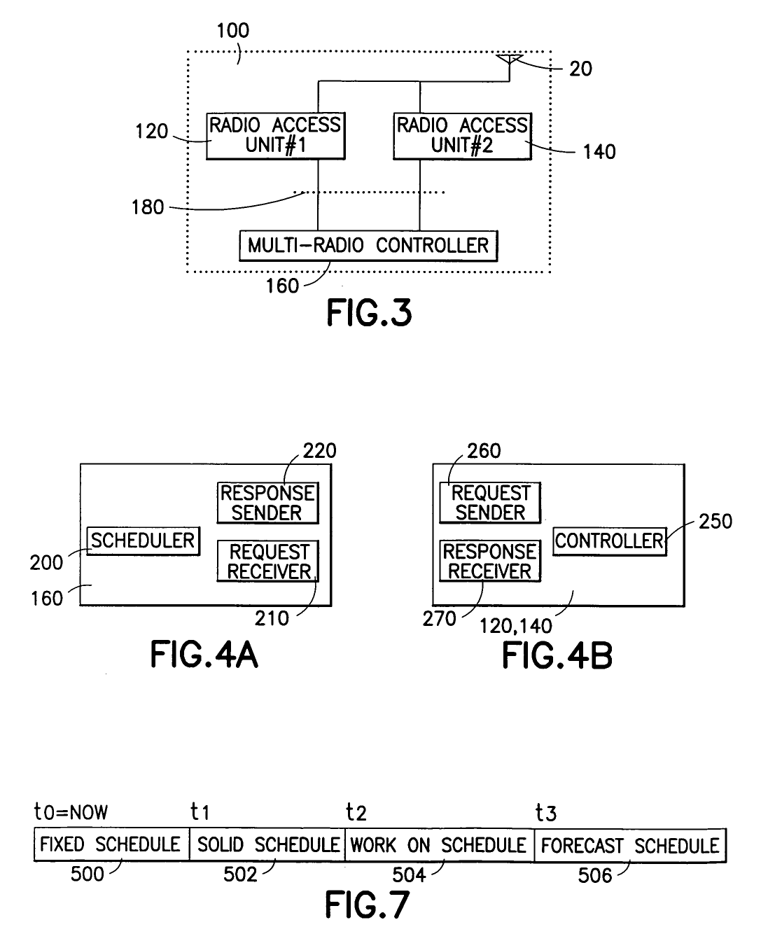

As illustrated in FIG. 4a, an embodiment of a multi-radio controller 160 includes a scheduling service controller (scheduler) 200 and may comprise a request receiver 210 for receiving scheduling requests comprising at least some of the radio independent scheduling parameters. The scheduler 200 provides radio access scheduling services for a plurality of the radio access units 120, 140 on the basis of value information of at least some of the radio independent scheduling parameters in received scheduling requests. Further, the MRC 160 may comprise a response sender 210 for sending a response to the scheduling request in a pre-specified form in accordance with the control interface 180 common to the radio access units 120, 140.

In an exemplary embodiment, as illustrated in FIG. 4b, a radio access unit 120, 140 comprises a controller 250 in charge of the functions related to communicating with the multi-radio controller 160 to use radio access scheduling services over the interface 180. The RAU controller 250 may control the functions related to the features in the radio access unit 120, 140. The controller 250 is configured to generate a scheduling request comprising value information of radio independent and radio dependent scheduling parameters in a pre-specified form in accordance with a predefined control interface common to the plurality of radio access units. The RAUs 120, 140 may also comprise a scheduling request sender 260 configured to send the scheduling request to the MRC 160 over the interface 180 and a scheduling response receiver 270 to receive a response to the request over the control interface 180. The controller 250, or a further controller, may be configured to control radio access transmission and/or reception in response to the received request.

Although the above apparatus has been depicted as one entity, different units and memory thereof may be implemented in one or more physical or logical entities. Although the units are separated in FIGS. 3, 4a and 4b, these functions could be implemented at least partially in a single module or device.

The MRC 160 may be a single physical apparatus operationally connectable to the radio access units 120, 140, and may be embodied as a chipset. The chipset or integrated circuit may be suitable for use in a mobile phone or a portable computer, for instance. The scheduling service related functionalities may be implemented at the MRC 160 by software, by hardware or a combination thereof.

Similarly, a radio access unit 120, 140 may be a single physical apparatus operationally connectable to the MRC 160. For instance, the radio access unit, or further modules thereof, may be a chipset or integrated circuit, which may be suitable for use in a mobile phone. The features may be implemented at the radio access unit apparatus by software, by hardware or a combination thereof.

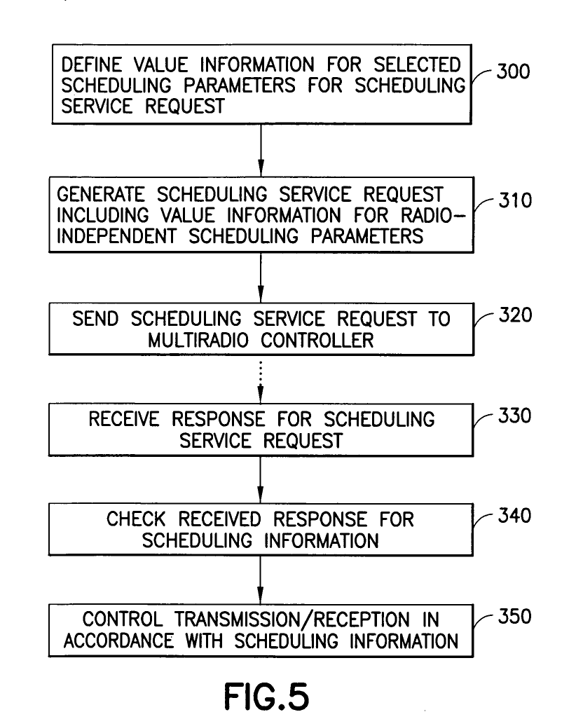

Some further aspects and embodiments of the above-identified apparatus(es) and the further blocks of FIGS. 3, 4a and 4b are illustrated further in connection with FIGS. 5, 6, 7, 8 and 9.

The apparatus 100, such as the SDR platform, may be any communications device comprising at least two RAUs 120, 140 capable of interfering with the operation of other radio access units. Some examples of such apparatus include a mobile station or a mobile phone, an entertainment device such as a game console, a laptop computing device, a personal digital assistant, an accessory device, or a digital image capture device having radio communication capabilities, or a combination of two or more such devices.

The apparatus may comprise a plurality of wireless transceivers, for instance operating according to a 2G wireless communications standard, such as the GSM (Global System for Mobile Communications), according to a 3G standard, such as the WCDMA (Wideband Code Division Multiple Access), according to a 4G or further generation standard, according to a WLAN (Wireless Local Area Network), WiMAX, Bluetooth® standard, or in accordance with any other suitable standardized or non-standardized wireless communication system/protocol.

Note also that at least one of the RAUs 120, 140 may be operable with the long term evolution (LTE) of the universal terrestrial radio access network (UTRAN), also known as E-UTRAN, the Release 8 version of which is described in 3GPP TS 36.300 and related specifications and standards. One or more of the RAUs 120, 140 may also be operable with future enhancements of LTE, such as LTE-A (LTE Advanced, which may also be referred to as “beyond Release 8”). One or more of the RAUs 120, 140 may also be operable to receive digital video broadcast (DVB) transmissions.

It should thus be appreciated that the particular capabilities of the RAUs 120, 140 are not to be construed as placing any type of limitation on the use of the exemplary embodiments of this invention described in reference to FIGS. 1, 2, 10, 11 and 12.

Continuing with the description of the MRC scheduler 200 found in FI20085480, “Co-existence between radio access units”, the MRC 160 provides a generic timeline and interface concept which can be used to define scheduling services for various types of current and future radio system(s)/protocol(s) supported by the radio access units 120, 140, such as one or more of the above-mentioned standards and their extensions (such as HSDPA, HSUPA and LTE in the case of 3GPP/UMTS), DVB-H, GPS, Galileo. However, it is again noted that the embodiments are not limited to any particular type of radio unit(s).

The use of a radio-independent interface 180 for scheduling services facilitates the addition of new radio units to an existing SDR platform. To make this feasible in a multi-radio device, a new radio is assumed to be controllable by the MRC 160 in accordance with the predefined form specified for the interface 180. Because the time domain behavior of a new radio is generally not known during the design of the SDR platform, a solution where a radio controller understands the behavior of all controlled radio protocols is not feasible. The scheduling control interface 180 is designed in a generalized manner to provide general-purpose scheduling services, which different RAUs 120, 140 can use to generate the air access requests they need. Examples of interference, which the MRC 160 may be configured to avoid or at least reduce, include: RF blocking (the receiver is unable to receive a full strength input signal due to a simultaneously active transmitter at a nearby frequency), wide band noise caused by non-ideal frequency synthesizers, harmonic frequencies of a transmitter located in a receiver band, and intermodulation caused by mixing together signals of two or more simultaneously active transmitters, where the formed new frequencies may be located in a receiver band.

Discussed now in further detail are the interface 180 and the actions in the MRC 160 and the RAUs 120, 140. FIG. 5 illustrates a method where the steps may be applied to a radio access unit (controller 250) 120, 140 requesting radio access scheduling services. In response to a need to request scheduling services, value information is defined 300 for selected ones of the scheduling parameters of the radio independent interface 180 for scheduling service requests. A scheduling service request in a predefined form required in the interface 180 is generated at 310, the request including the value information on radio-independent scheduling parameters desired by the radio access unit in question. The scheduling service request is sent 320 to the multi-radio controller 160 over the interface 180.

Later, a response to the scheduling service request is received 330 from the MRC 160 over the interface 180. Scheduling information in the received response is checked 340. Transmission or reception is controlled 350 in accordance with the scheduling information in the received response. The scheduling information may simply indicate if the requested schedule was allowed or denied. In one embodiment, the response may comprise further information on an allowed schedule, such as a general schedule calculated for the radio access units 120, 140.

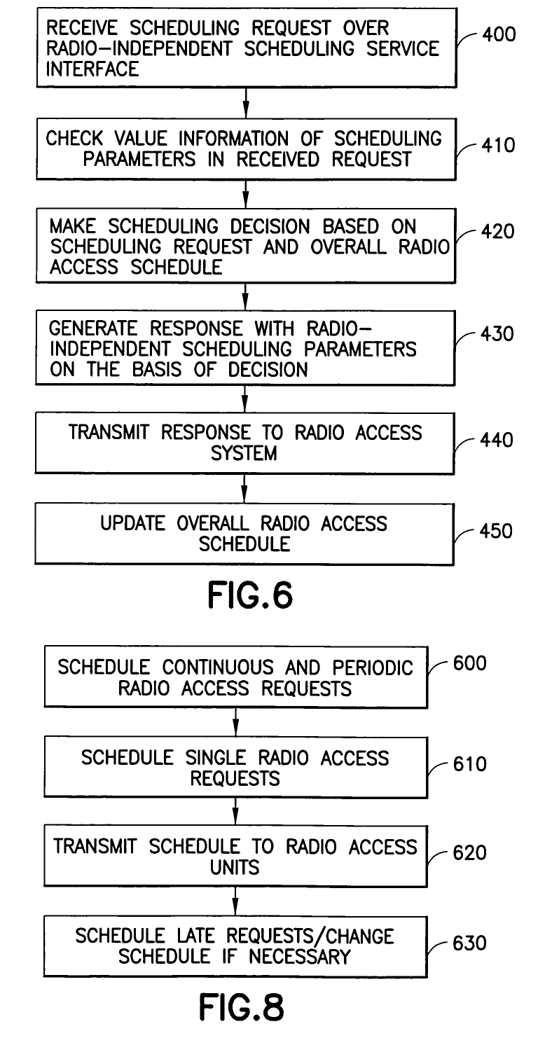

FIG. 6 illustrates a method that may be applied to the multi-radio controller 160 providing radio access scheduling services over the interface 180 common to the radio access units 120, 140.

A scheduling request is received 400. For instance, the request may be received from a radio access unit 120, 140 operating in accordance with the method of FIG. 5. The scheduling request comprises value information on at least some of the scheduling parameters in a pre-specified form in accordance with the radio independent control interface common to the radio access units. Value information on the received parameters is checked 410. A radio access scheduling decision is made 420 on the basis of the value information on at least some of the scheduling parameters in the request and an overall radio access schedule. The overall radio access schedule maintains information on scheduled radio transmissions of the radio access units 120, 140 controlled by the multi-radio controller 160.

A number of techniques and algorithms exist to implement the radio access scheduling, and such algorithms are not described in detail herein. For instance, requested transmission or reception time(s) is compared to already allowed transmission or reception times, but also further parameters may be taken into account. If there is no reservation in the overall radio access schedule for the requested time slot, i.e. no other radio needs access at the requested time slot, the request may be directly allowed. If there is at least a partial overlap, the request may be rejected or further radio access related control action may be initiated, for instance to reduce transmission power.

A response to the request is generated at 430. The response may at least indicate whether or not the request was allowed. The response is formed to meet a pre-specified form in accordance with the control interface 180 common to the radio access units 120, 140. The response is sent 440 to the requesting radio access unit 120, 140.

The overall radio access schedule is updated at 450 in accordance with the scheduling decision of step 420, if necessary. The overall radio access schedule may be implemented in various ways and it may generally refer to a set of requests received from the radio access units 120, 140 and the decisions made by the MRC 160 on the basis of the requests.

In one embodiment, the MRC 160 is arranged to use the requested transmission time (window) as a main parameter when making the radio access scheduling decisions at 420. Hence, the overall radio access schedule may also be updated based on and reflecting the allowed time slots. The overall radio access schedule may reflect rules created based on the scheduling decisions 420.

It is to be noted that the above features represent only some examples of available ways to implement arranging a scheduling service over the radio-independent interface 180 between the scheduling service provided, such as the multi-radio controller 160, and scheduling service users, such as the radio access units 120, 140. Various modifications can be made and some of the steps may be carried out in a different order. For instance, step 450 may precede step 440, and it may be carried out directly after the decision of step 420.

The control interface 180 between the radio access units 120, 140 and the multi-radio controller 160 may be pre-specified with two or more categories of scheduling requests, i.e., the entities communicating over the interface 180 are able to differentiate between such categories of scheduling requests. Each radio access unit 120, 140 may be configured to select an appropriate category for a scheduling request being generated 310 and specify the scheduling request category in a scheduling request. The multi-radio controller 160 may be arranged to process the scheduling requests in accordance with such category information, and serve a received scheduling request in accordance with its category.

From the point of view of MRC 160 scheduling, radio communication may be classified into three categories: periodic, single and continuous. Periodic classification means that radio operation (transmission or reception) is repeated at fixed intervals. The single classification is used to schedule occasional, non-periodic operations. The continuous classification is for radio operation which is active continuously or for a long time as compared to the scheduling time, for example an FM radio receiver.

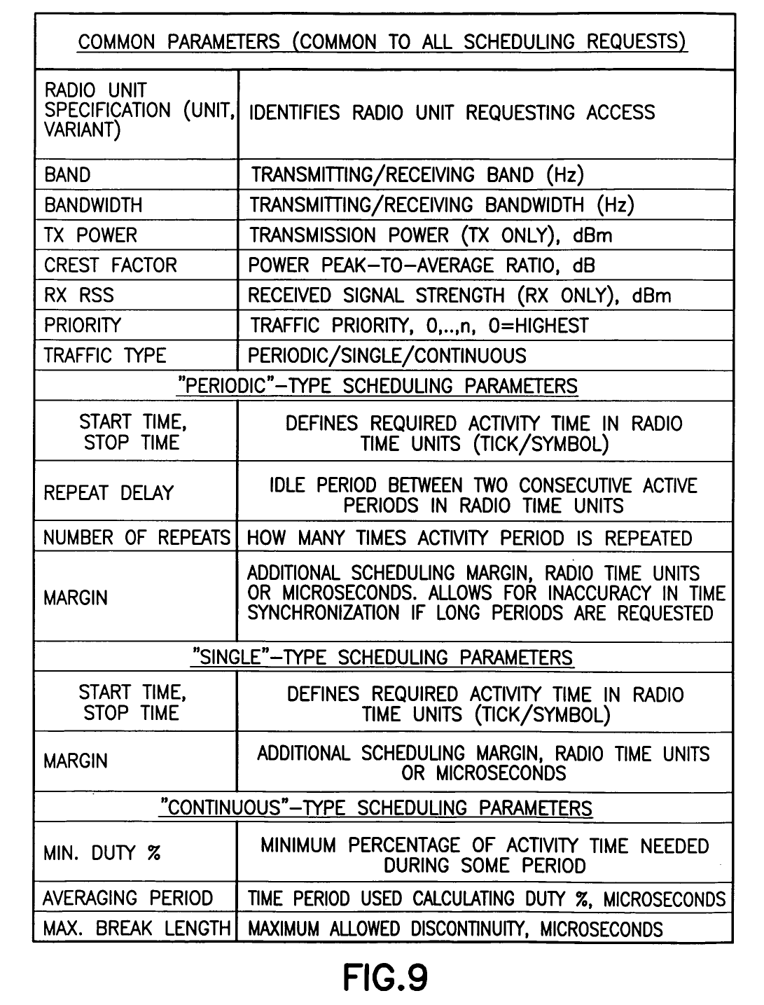

There may thus be a first scheduling request category for periodic type of radio access, a second scheduling request category for continuous type of radio access, and a third scheduling request category for single type of radio access. However, these are only examples, and various other categorizations may be used for differentiating scheduling services. Some non-limiting examples of parameters for use in scheduling requests of these particular examples of categories are illustrated in the table shown in FIG. 9.

The set of radio independent scheduling parameters over the radio independent interface 180 may comprise a first sub-set of parameters for use in each scheduling request and a second sub-set of scheduling parameters specific to a scheduling request category.

As can be see in FIG. 9, there may be a number of scheduling parameters common to all scheduling request categories. Some or all of these common scheduling parameters may be used in all scheduling request categories, i.e. it may be adequate to include values only for some of the parameters in certain types of requests. Further, some of these parameters may be applied to a unit applying different or no categorization of scheduling requests and parameters.

At least some of the scheduling requests or scheduling request categories may be prioritized. Such priority information may influence the processing of a request. The MRC 160 may be arranged to check priority information associated with the received scheduling request. This may be carried out in connection with checking information in the received scheduling request at block 410, for example. The priority information may be explicitly included by an RAU 120, 140 (310) in the scheduling request, or it can be derived, e.g., on the basis of the scheduling request category.

The priority associated with the request (category) may affect the processing (420) or processing order of the requests, or even an already made scheduling decision. In one embodiment, the MRC 160 is arranged to override a previously made scheduling decision for a first action if a newly requested second action has a higher priority than the first action, and if these two actions interfere with each other.

A specific time window may be defined for each of the categories of scheduling requests. The MRC 160 may be pre-specified with, or may dynamically allocate arrival time(s) or time window(s) scheduling request category specifically, and may be arranged to apply such time windows when receiving (at block 400) scheduling requests. A radio access unit 120, 140 may be informed of, or may be pre-specified with, timing information on scheduling request categories and may send (at block 320) a scheduling request in a time window allocated to the category of the scheduling request. In another embodiment, the radio access units 120, 140 may send scheduling requests when necessary, and the MRC 160 handles received scheduling requests by applying a scheduling request processing or serving algorithm, for instance causing processing of the requests in a predefined order and/or within a pre-specified time window.

FIG. 7 illustrates an example of how time windows may be allocated to different types of scheduling requests.

Assume as an example that a scheduling timeline has four different time zones. In the x-axis t0 means the current time, and t1, t2 and t3 future times such that t3 is the furthest in the future. The scheduling timeline defines a basis for an air interface scheduling service the MRC 160 provides for radio access units 120, 140.

Starting from the right, the first zone 506 is referred to as a forecast schedule. First, the MRC 160, or the scheduler 200 thereof, processes scheduling requests of the periodic and continuous types, and allocates time to them. This can be based on a prioritization algorithm if interference is detected between requested actions, for example, by first allocating time to a request of highest priority. There are at least two reasons for processing the periodic requests first: they are usually known well in advance, and high priority traffic, such as a cellular voice call, typically uses periodic radio access.

The second zone 504 is referred to as work on schedule. Periodic requests are allocated before time t3 and the next step is to allocate single schedule requests. If a requested action has a higher priority than a previously accepted periodic scheduling action, and if these two actions interfere with each other, the previously made scheduling decision may be overridden. In that the calculated intermediate schedule has not yet been communicated back to the radio access units 120, 140, changes and adjustments may be easily made to the schedule.

The third zone 502 may be referred to as a solid schedule. After time t2, the overall schedule should be completed for all type of schedule requests, and it can be communicated to the RAUs 120, 140 over the interface 180. However, there may be situations where the scheduling demand is not known before time t2. For example, this may occur when using a fast retransmission in the case of a failure in some radio access network protocols. While these decisions can still be made between times t2 and t1, they may require changes in the schedule already communicated back to the radio access units 120, 140 and, in that sense, are costly and may require special arrangements.

The fourth zone 500 is referred to as a fixed schedule, where it is assumed that scheduling decisions cannot be changed when less than t1 time is left. This time limit may be seen to represent a physical constraint of the underlying platform. That is, RF hardware should be configured correctly before being used, and this requires some finite amount of time. Communicating the schedule to the radio access units 120, 140 using, e.g., a shared bus also introduces latency, and thus affects the timing parameters t1 . . . t3.

The actual values of the timing parameters t1 . . . t3 may be unit design parameters. By further analysis and optimization, a desirable balance may be made between the quality of the MRC schedule and RAU requirements such as, for example, buffering, computation load and communication latency. For example, if the scheduler 200 in some platform has more computational resources and a faster communication bus between radios, t2 may be moved closer to t1 and the need to handle exceptional schedule requests is reduced.

FIG. 8 illustrates a method of processing scheduling requests. The MRC 160 may comprise a buffer for incoming scheduling requests. The MRC 160 may be arranged to serve the arrived scheduling requests in the manner illustrated in FIG. 8. In step 600, continuous and periodic scheduling requests are served first. Then, in step 610, single radio access (scheduling) requests are served. In step 620, a resulting schedule is sent to the RAUs 120, 140. It should be noted that, instead of or in addition to informing each RAU 120, 140 separately, the MRC 160 may send an overall schedule to all RAUs 120, 140 in response to a scheduling request. In step 640, possible later requests are served. Any necessary changes may also be made to the schedule.

In one embodiment the MRC 160 is kept aware of the radio time of each RAU 120, 140. Each RAU 120, 140 is responsible for keeping the MRC 160 up to date of its time, and to report changes therein, for example time advances. Thus, a controlling apparatus may be provided, the controlling apparatus being configured to: search for at least one predetermined conversion function; check a system time of at least one radio protocol; define a common multi-radio reference time; convert the system time of at least one radio protocol to the common multi-radio reference time with the at least one conversion function and process control commands in the common multi-radio reference time, and/or convert the common multi-radio reference time to the system time of at least one radio protocol with the at least one conversion function and process control commands in the system time.

In one embodiment the MRC 160 is configured to perform these functions so as to provide a common multi-radio reference time and system time for at least some of the RAUs 120, 140, but it is also possible to implement the conversion function outside of the MRC 160. The MRC 160 may keep track of static offsets of each of the RAUs 120, 140, which may be updated, for example, when a GSM transceiver synchronizes with a base station.

Having thus described one suitable and exemplary embodiment of a MRC scheduler, i.e., the one described in FI 20085480, “Co-existence between radio access units”, it suffices to say that the exemplary embodiments of this invention assume that the MRC 12 of FIG. 1 is capable of detecting and solving multiradio interference problems proactively. The MRC 12 has knowledge of the exact time periods when each transmitter is on, and whether a particular transmitter is capable of blocking reception of a particular receiver when it is on (transmitting).

The basic operation is illustrated in FIG. 1. First, all radios 14 (corresponding to the RAUs 120, 140 shown in FIGS. 3 and 4B) send their scheduling request to the MRC 12. The scheduling requests are assumed to contain information that is descriptive at least of radio transmission start and end time, channel width and bandwidth. In addition, there may be certain RF-related parameters needed to detect interference such as, but not limited to, transmission power and signal peak-to-average ratio (crest factor). The priority parameter may be associated with each radio 14, with each individual request, or with a combination of radio/request. The priority is used in a case of interference conflict to decide which radio is blocked. The MRC 12 compares the received schedule requests and determines those time periods, if any, when two or more radios disturb each other. The MRC 12 resolves these interference problems by, for example, denying the lower priority radio 14 to permit the higher priority radio to operate as desired.

In a case where a higher priority transmitter blocks a lower priority receiver, the reception is typically lost during that time. In accordance with the exemplary embodiments of this invention the MRC 12 informs the affected radio receiver 14 of the time(s) during which its reception will be blocked during a particular scheduling window or interval. The affected radio 14 receiver can then use this information to mark those symbols received during the blocked time period as erasures, prior to executing error correction algorithms. This type of operation significantly increases error correction performance, such as FEC performance. For example, a Reed-Solomon decoder used in a DVB-H receiver can correct 32 erroneous symbols in a 255 symbol frame if the error positions are not known in advance, and can correct up to 64 erroneous symbols in a case where the error positions are known (or any combination of unknown error positions n and known error positions m, as long as the condition 2*n+m<=64 is met).

FIG. 1 thus presents a technique for the MRC 12 to collect the information needed to inform a FEC unit of a receiver of erasures during a multiradio scheduling process.

1) All radios 14 send their desired schedule requests to the MRC 12.

2) The MRC 12 compares the received requests, detects possible interference problems between simultaneously active radios 14, and resolves them by possibly denying one or more of the radios (for example, based on priority).

3) The MRC 12 sends granted schedule information back to the radios 14. At this step, in addition to sending the scheduling information (such as was described above with respect to FIGS. 3-9), the MRC 12 sends information that identifies those time periods when reception is blocked due to a simultaneously active transmitter.

4) The receiver of the affected radio(s) 14 uses the information to mark corresponding symbols as erased for the FEC algorithm, thereby improving the error correction capability of the FEC algorithm.

FIG. 2 illustrates a further exemplary embodiment of this invention. In addition to considering the interference between simultaneously active radios, the MRC 12 provides a single point from which to inform the radios 14 of an external event 18 capable of disturbing or disrupting operation of the radio 14. This information is then used when calculating the schedule, and the information descriptive of corrupted reception periods caused by the external event disturbance may be transferred to the radio 14 receivers in a similar manner.

FIG. 2 thus presents a method for non-radio interference to be used by the MRC 12 to determine reception blocking periods. As one example, when a mobile computer is used to take a picture (capture an image) an activation of the flash may disturb radio reception. Step 1b in FIG. 2 illustrates sending information to the MRC 12 about an event external to the SDR platform 10, and which may be capable of causing radio interference (e.g., disturbing or disrupting radio reception). The other steps 1-4 are similar to those described above for FIG. 1.

It should be noted that due to the SDR platform 10 providing multiradio scheduling as a SDR platform-level service, individual radios 14 need not be aware of the reason or the source of a reception failure period. In addition, the ability to also handle external interference sources as in FIG. 2 means that the radios. 14 need not have explicit knowledge of the source or type of the external interference.

The exemplary embodiments of this invention may be extended to other radio modem functionalities or algorithms which may benefit from the information concerning those time periods when radio reception is blocked. As two exemplary and non-limiting examples, a streaming (video or audio) application can know beforehand that it should launch an interpolation algorithm to estimate missing data, and a processor or some other part of the system can be put into power-safe state (for example by gating off a clock signal, or lowering the operating voltage) when the system has a priori knowledge that reception is blocked and that there will not be any meaningful incoming data to process.

It is noted with respect to the length of the erasure, as compared to a typical code block, that time-interleaving may be used to temporally spread the code block so that, for example, a GSM transmit burst (0.57 ms) or an LTE burst (1 ms) may erase only a few symbols in one code block, which can be corrected as the number of erasures is divided amongst multiple code blocks.

As an exemplary use case, consider that DVB-H uses interleaving to spread MPE-FEC frames in time so that the frame duration is typically in the range of between 100 ms-500 ms, depending on the parameters used. As the frame length is 255 symbols, one GSM TX burst is capable of erasing about 0-2 symbols and the LTE burst about 1-3 symbols. These erasures can be corrected by the Reed-Solomon decoder, for a case of a RS(191,64) code, which is able to correct 32 erroneous symbols, 64 erasure symbols or any combination thereof, so that one error is counted as two erasures. Assume as a non-limiting case 100 ms interleave spreading and a 0.57 ms GSM transmit burst, repeated at 4.56 ms intervals. In this case the MPE-FEC symbol interval is about 0.39 ms, and as a worst case one GSM burst can block reception of two symbols. During the 100 ms frame duration there are 22 GSM transmit bursts, causing as a worst case 44 erased symbols. Because this is less than 64 (the maximum number of erasures RS(191,64) can correct), those symbols can be corrected when the MRC 12 informs the radio 14 receiver of their locations in time. If the positions of the blocked symbols are not known, the blocked symbols would be handled as normal errors by the MPE-FEC decoder (not as erasures). In that 44>32, the affected MPE-FEC frame cannot be corrected. In that the second harmonic of the 800 MHz GSM band is known to disturb DVB-H reception, the exemplary embodiments of this invention can be used to make the DVB-H radio 14 receiver more robust.

The DVB-H/GSM case is presented simply to show the utility of the exemplary embodiments of this invention and, in practice, other techniques may be used to alleviate the GSM transmit burst interference to the DVB-H reception. The exemplary embodiments of this invention can find particular utility in those cases when interference is caused some new radio 14 which may not exist when the victim radio is designed or installed in the SDR platform 10. This type of situation is likely to arise in future SDR devices, where radios can be loaded or updated at any time during the lifetime of the device. The use of these exemplary embodiments of the invention thus enables the basic coexistence of multiple and possibly changing radios 14 in the SDR platform 10.

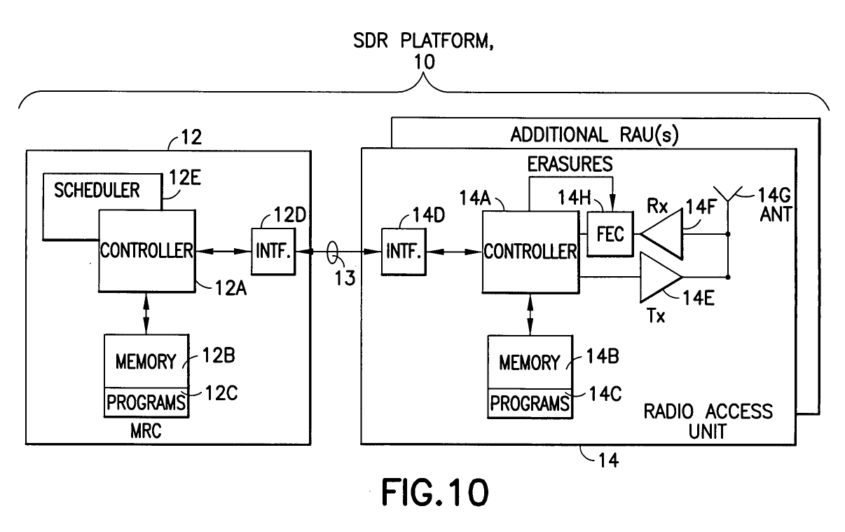

FIG. 10 shows the various components of the SDR platform 10 in greater detail. The SDR platform 10 includes the MRC 12 and a plurality of the radios (RAUs) 14. A suitable communication link or bus 13 bidirectionally connects the MRC 12 and the RAUs 14. The MRC 12 includes a controller 12A, which may be embodied as one or more data processors that operate with a computer-readable memory medium or, more simply, a memory 12B to execute program instructions 12C. At least some of the program instructions are operable for implementing the MRC-related aspects of the exemplary embodiments of this invention. The controller 12A is coupled to the bus 13 via a suitable interface 12D. The MRC 12 includes a scheduler function or module 12E, which may be implemented in whole or in part by one or more of the programs 12C. The scheduler 12E may be the same as or similar to the scheduler 200 that was described above with reference to FIGS. 3-9, or it may operate in a completely different manner. An aspect of the exemplary embodiments of this invention is that the scheduler 12E functionality is modified so as to provide the receiver blocking information to affected RAUs 14, as was described above. Alternatively, this functionality may be provided by a unit or module separate from the scheduler 12E, and that operates on scheduling information provided by the scheduler 12E.

An exemplary RAU 14 includes a controller 14A, which may be embodied as one or more data processors that operate with a memory 14B to execute program instructions 14C. At least some of the program instructions are operable for implementing the RAU—related aspects of the exemplary embodiments of this invention. The controller 14A is coupled to the bus 13 via a suitable interface 14D. While a given RAU 14 may include just a radio frequency transmitter (Tx) 14E, or just a radio frequency receiver (Rx) 14F, both are shown in FIG. 10 embodied as a transceiver coupled to one or more antennas 14G. The RAU 14 is assumed to include an error correction unit, such as a FEC decoder 14H in a Rx path, such as the above-mentioned Reed-Solomon or other type of FEC decoder. In accordance with an aspect of this invention the controller 14A is arranged to indicate erasure information (received symbols known to be corrupted) as erasures 14I to the FEC decoder 14H to enhance the performance of the FEC decoder 14H. The erasure information is received as part of the signaling over the bus 13 from the MRC 12, as was described above.

The various components/devices and apparatus shown in FIG. 10 may be embodied in hardware, software or as a combination of hardware and software. Note that the FEC decoder 14H may be embodied in hardware or entirely in software. The MRC 12 may be embodied in whole or in part as an integrated circuit and/or each of the RAUs may be embodied in whole or in part as an integrated circuit. Note that the entire SDR platform 10 may be embodied as a single integrated circuit, or as two or more integrated circuits.

It should be appreciated that at least one of the RAUs 14 may be configured for performing cellular radio frequency communications (e.g., GSM or LTE), while another one of the RAUs 14 may be configured for performing non-cellular radio frequency communications (e.g., it may be embodied as a DVB receiver), as several non-limiting examples.

Benefits that are obtained by the use of these exemplary embodiments include, but are not limited to:

i) Information about corrupted reception periods is exact both in the time sense (the MRC 12 has exact information of when a certain radio 14 is blocked) and in accuracy (false alarm erasures can be avoided).

ii) There is no need to implement dedicated transmitter-receiver specific signaling between every simultaneously active transmitter-receiver pair. Because the SDR platform 10 provides the MRC 12 scheduling (scheduler 200 in FIG. 3a) as a platform level service, a new radio that is loaded/instantiated to the SDR device can use this invention even though existing radios 14 are not aware of the new radio. A designer of a radio targeted for use in an SDR device does not need to be concerned how operation of the new radio may disturb other simultaneously active radios.

iii) The use of these exemplary embodiments enables phenomenon than transmit antenna-to-receive antenna interference to be used to mark erroneous symbols as erasures, so long as the MRC 12 has knowledge of the occurrence of the phenomenon. Examples include high power consumption peaks of a device, or the activation of a flash when capturing a digital image. These types of phenomenon can disturb reception, or a certain radio may have a conflict with another radio simultaneously accessing shared computing resources. Because of the single control point in the SDR platform 10, i.e., the MRC 12, it is straightforward to incorporate phenomenon that disturb radio reception by making the necessary information available to the MRC 12.

Based on the foregoing it should be apparent that the exemplary embodiments of this invention provide a method, apparatus and computer program product(s) to enhance the operation of a FEC decoder in a multiradio type of platform, which may be a software defined radio type of platform.

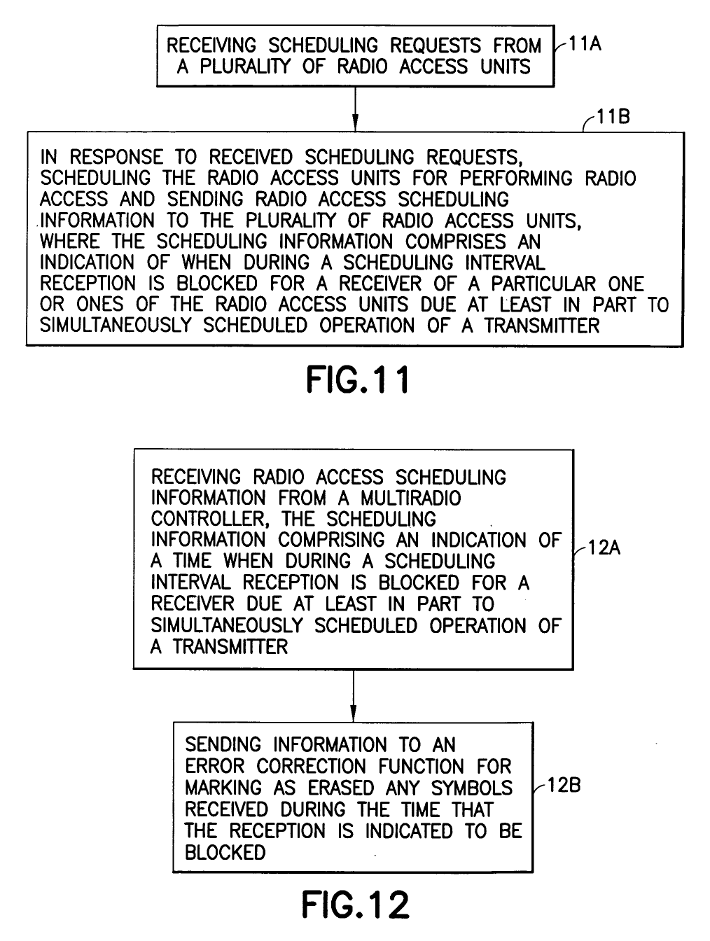

FIG. 11 is a logic flow diagram that illustrates the operation of a method, and a result of execution of computer program instructions, for the MRC controller of FIGS. 1 and 10 in accordance with the exemplary embodiments of this invention. At Block 11A there is a step of receiving scheduling requests from a plurality of radio access units. At Block 11B there is a step, executed in response to received scheduling requests, of scheduling the radio access units for performing radio access and sending radio access scheduling information to the plurality of radio access units, where the scheduling information comprises an indication of when during a scheduling interval reception is blocked for a receiver of a particular one or ones of the radio access units due at least in part to simultaneously scheduled operation of a transmitter.

FIG. 12 is a logic flow diagram that illustrates the operation of a method, and a result of execution of computer program instructions, for one of the radio access units of FIGS. 1 and 10 in accordance with the exemplary embodiments of this invention. At Block 12A there is a step of receiving radio access scheduling information from a multiradio controller, the scheduling information comprising an indication of a time when during a scheduling interval reception is blocked for a receiver due at least in part to simultaneously scheduled operation of a transmitter. At Block 12B there is a step of sending information to an error correction function for marking as erased any symbols received during the time that the reception is indicated to be blocked.

The various blocks shown in FIGS. 11 and 12 may be viewed as method steps, and/or as operations that result from operation of computer program code, and/or as a plurality of coupled logic circuit elements constructed to carry out the associated function(s).

The exemplary embodiments of this invention also encompass a step of receiving scheduling requests from a plurality of radio access units; in response to received scheduling requests, scheduling the radio access units for performing radio access and sending radio access scheduling information to the plurality of radio access units, where the scheduling information comprises an indication of when during a scheduling interval reception is blocked for a receiver of a particular one or ones of the radio access units due at least in part to simultaneously scheduled operation of a transmitter and/or an occurrence of an external event capable of disrupting radio reception.

The exemplary embodiments of this invention also encompass an apparatus that comprises means for receiving scheduling requests from a plurality of radio access units; means, responsive to received scheduling requests, for scheduling the radio access units for performing radio access and for sending radio access scheduling information to the plurality of radio access units, where the scheduling information comprises an indication of when during a scheduling interval reception is blocked for a receiver of a particular one or ones of the radio access units due at least in part to simultaneously scheduled operation of a transmitter and/or an occurrence of an external event capable of disrupting radio reception.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, and as was noted above, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the GSM, DVB-H and E-UTRAN (UTRAN-LTE) systems, as several examples, it should be appreciated that the exemplary embodiments of this invention are not limited for use with only these particular types of wireless communication system, and that they may be used to advantage in other wireless communication systems either currently specified or to be specified in the future.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. An apparatus, comprising:
a controller configured to provide radio access scheduling services for a plurality of radio access units in response to scheduling requests received from the plurality of radio access units, said controller configurable with a scheduler that is configured to schedule radio access in response to received scheduling requests and to send radio access scheduling information to the plurality of radio access units;
where said scheduling information comprises an indication of when during a scheduling interval reception is blocked for a receiver of a particular one or ones of the radio access units due at least in part to simultaneously scheduled operation of a transmitter.

2. The apparatus as in claim 1, where the scheduling information further comprises an indication of when during the scheduling interval reception is blocked for a receiver of a particular one or ones of the radio access units due to an occurrence of an external event capable of disrupting radio reception.

3. The apparatus as in claim 1, where said controller comprises a part of a multiradio controller embodied in a software defined radio platform.

4. The apparatus as in claim 1, where at least one of the radio access units is configured for performing one of cellular radio frequency communications and non-cellular radio frequency communications.

5. A method, comprising:
receiving scheduling requests from a plurality of radio access units; and
in response to received scheduling requests, scheduling the radio access units for performing radio access and sending radio access scheduling information to the plurality of radio access units;
where the scheduling information comprises an indication of when during a scheduling interval reception is blocked for a receiver of a particular one or ones of the radio access units due at least in part to simultaneously scheduled operation of a transmitter.

6. The method as in claim 5, where the scheduling information further comprises an indication of when during the scheduling interval reception is blocked for a receiver of a particular one or ones of the radio access units due to an occurrence of an external event capable of disrupting radio reception.

7. The method as in claim 5, executed by a multiradio controller embodied in a software defined radio platform.

8. The method as in claim 5, where the scheduled radio access for at least one of the radio access units enables the radio access unit to perform one of cellular radio frequency communications and non-cellular radio frequency communications.

9. The method as in claim 5, performed in response to the execution of computer program instructions stored in a memory medium.

10. A method comprising:
receiving radio access scheduling information from a multiradio controller, the scheduling information comprising an indication of a time when during a scheduling interval reception is blocked for a receiver due at least in part to simultaneously scheduled operation of a transmitter; and
sending information to an error correction function for marking as erased any symbols received during a time that the reception is indicated to be blocked.

11. The method as in claim 10, where the scheduling information further comprises an indication of when during the scheduling interval reception is blocked due to an occurrence of an external event capable of disrupting radio reception.

12. The method as in claim 10, executed by one of a plurality of radio units embodied in a software defined radio platform, and where the scheduling information is received from a multiradio controller.

13. The method as in claim 12, where the radio unit performs one of cellular radio frequency communications and non-cellular radio frequency communications in accordance with the scheduling information.

14. The method as in claim 12, performed in response to the execution of computer program instructions stored in a memory medium.

15. An apparatus, comprising:
an error correction function; and
a controller configured to receive radio access scheduling information in response to a scheduling request sent to a multiradio controller, said controller responsive to said radio access scheduling information comprising an indication of a time when during a scheduling interval reception is blocked for a receiver of the apparatus, to send information to the error correction function for marking as erased any symbols received during a time that the reception is indicated to be blocked.

16. The apparatus as in claim 15, where the scheduling information further comprises an indication of when during the scheduling interval reception is blocked for the receiver due to an occurrence of an external event capable of disrupting radio reception.

17. The apparatus as in claim 15, where said controller comprises part of a radio access unit embodied with at least one other radio access unit and with a multiradio controller in a software defined radio platform.

18. The apparatus as in claim 17, where said radio access unit is configured for performing one of cellular radio frequency communications and non-cellular radio frequency communications.

19. The apparatus as in claim 15, where the information comprising an indication of a time when during a scheduling interval reception is blocked for a receiver of the apparatus comprises information descriptive of when a transmitter, that comprises part of at least one other radio access unit, is scheduled for operation by the radio access scheduling information.

20. The apparatus as in claim 15, embodied at least partially as an integrated circuit.
